(19) United States
(12) Patent Application Publication
(10) Pub. No.: US 2008/0032904 A1
(43) Pub. Date: Feb. 7, 2008

(54) Perfluoropolyether Oil Composition

(76) Inventors: Yuji Watanabe, Ibaraki (JP); Yasumichi Kido, Ibaraki (JP); You Doi, Ibaraki (JP); Miyuki Hashida, Ibaraki (JP); Toshio Nitta, Ibaraki (JP); Tatsuya Hashimoto, Ibaraki (JP); Akira Otani, Ibaraki (JP); Jiro Yurimoto, Ibaraki (JP)

Correspondence Address: BUTZEL LONG, 350 SOUTH MAIN STREET, SUITE 300, ANN ARBOR, MI, 48104, US

(21) Appl. No.: 11/662,860

(22) PCT Filed: Aug. 30, 2005
(86) PCT No.: PCT/JP05/15732

§ 371 Date: Mar. 14, 2007

(30) Foreign Application Priority Data
Sep. 14, 2004 (JP) 2004-266937
Mar. 3, 2005 (JP) 2005-058633
Apr. 28, 2005 (JP) 2005-130871

(51) Int. Cl. C10M 169/02; C08L 71/00; C10M 107/38; C23F 11/00; C10M 133/16; C10M 149/14

(52) U.S. Cl. 508/590

(57) ABSTRACT

A perfluoropolyether oil composition, which comprises a perfluoropolyether base oil, preferably a thickener-containing perfluoropolyether base oil, and a fluorine-containing di- or mono-amide-based compound having a perfluoropolyether group, where 0.01 to 50% by weight of the amide-based compound, based on total weight of the base oil and the amide-based compound, is contained when the perfluoropolyether oil composition is used as a lubricating oil composition, particularly grease, and 0.01 to 90% by weight thereof is contained, when the perfluoropolyether oil composition is used as an electrode-coating agent for a cell. The perfluoropolyether oil composition shows a metal surface protective action against corrosive gases such as sulfide gases, etc. without deteriorating the abrasion resistance, and also shows a distinguished high temperature durability even in the presence of graphite or molybdenum disulfide. Furthermore, creeping-up of the electrolytic solution along the electrodes or leakage thereof can be suppressed only by its coating onto the electrode surfaces in the cell.

### TECHNICAL FIELD

The present invention relates to a perfluoropolyether oil composition, and more particularly to a perfluoropolyether oil composition having a metal surface-protective action against corrosive gases such as sulfide gases, etc. and also when coated onto the electrode surface of a cell, an action to suppress creeping-up of an electrolytic solution along the electrode or the resulting leakage.

### BACKGROUND ART

Grease is widely used as a lubricant for a variety of machinery including automobiles, electric machines and appliances, construction machines, information technology devices, industrial machinery, machine tools, etc., and parts making up of the machinery. Due to recent trends of speed-up, size reduction, higher performance, and lighter weight of the machinery, the temperature, at which peripheral equipment is used, now tends to be elevated higher and higher.

Shaped articles of resin and rubber have been now used more increasingly to meet the requirements for lighter weight, lower cost, higher sealability, etc., while much higher sealability is still desired due to much noiseless requirements.

In such a situation, the metallic parts have been more frequently exposed to atmospheres of corrosive gases generated from the resins or rubber used much more at elevated temperatures or for the purpose of attaining a higher sealability, for example, a hydrogen sulfide gas, a hydrogen chloride gas, a sulfur dioxide gas, an ammonia gas, etc., or often exposed to corrosive gases incoming from the outside under severe use conditions.

To solve such a corrosion problem of metallic parts by corrosive gases, it is proposed to suppress permeation of hydrogen sulfide and to prevent contact materials from corrosion by a grease comprising silicone oil and fluororesin.

Patent Literature 1: JP-A-59-189511

According to Patent Literature 1, fluorine-containing compounds such as fluorocarbon oil or fluoroester, fluorine-modified paraffin oil, fluorine-modified ester oil, etc. are said to have similar effects besides fluorosilicone oil. However, all of these fluorine-containing compounds have not the same level of effect on suppression of hydrogen sulfide permeation, and the fluorosilicone oil can suppress the permeation of hydrogen sulfide, but has a poor abrasion resistance, resulting in abrasion of contact materials. The fluoroester, fluorine-modified paraffin oil, or fluorine-modified ester oil has a poor heat resistance, and cannot be used in high temperature atmospheres. This is a problem.

On the other hand, the following Paten Literature 2 proposes to use fluorogrease comprising perfluoropolyether having repeat units represented by:
—(CH₂CF₂CF₂O)ₐ—(CHClCF₂CF₂O)_{b}—(CCl₂CF₂CF₂0)_{c}—(CHFCF₂CF₂O)_{d}—(CFClCF₂CF₂O)ₑ—(CF₂CF₂CF₂O)_{f}—
as a base oil, and 0.5 to 60% by weight of fluororesin on the basis of total weight of the composition to improve the heat resistance and chemical resistance, though making no mention of permeability of corrosive gases.

Patent Literature 2: JP-B-2-32314

The following Patent Literature 3 also proposes fluorogrease with distinguished washing susceptibility, abrasion resistance, and leakage resistance, which comprises perfluoropolyether base oil, and at least one of metal salts of aliphatic dicarboxylic acid, monoamide mono-carboxylic acid or a monoester carboxylic acid as a thickener, though making no mention of corrosion resistance to corrosive gases.

Patent Literature 3: JP-A-2001-354986

Furthermore, the following Patent Literature 4 proposes fluorooil adding a fluorine-containing organic amide-based compound, though making no mention of corrosion resistance to corrosive gases.

Patent Literature 4: JP-A-2001-207186

The following Patent Literature 5 discloses that a fluorine-based lubricant having a corrosion preventing effect, which comprises a fluorine-containing organanophosphorus-based compound, a fluorine-containing organothiophosphorus-based compound, and a fluorine-containing organoamido-phosplorus-based compound, but the disclosed corrosion-preventing effect results only from exposure tests in a 100% humidity mist chamber, though making no test of corrosion resistance to corrosive gases.

Patent Literature 5: JP-A-6-136379

Sintered oilless bearings for use at high temperatures under high loads are often incorporated with a solid lubricant such as graphite, molybdenum disulfide, etc. and to meet more and more severe use conditions, the amount of solid lubricant incorporated tends to increase. The solid lubricant is used not only as materials for sintered oilless bearings, but more often existed in the peripheral situations of the bearings.

In such situations, lubricants are unintentionally to be brought into contact with or exposed to graphite or molybdenum sulfide, and the perfluoropolyether oil is no exception. Among a wide variety of the perfluoropolyether, the present inventors have now found that those with (CF₂O)ₙ groups as repeat units in the polymers have a poor durability at high temperatures, e.g. about 200° to about 250° C., and are evaporated off or volatilized off at a high rate of disappearance, particularly in the presence of graphite or molybdenum disulfide.

The cells can be broadly classified into primary cells, secondary cells (chargeable cells), etc., but any one of cells is made up of an electrode and an electrolytic solution. When a voltage is applied to the electrodes, the electrolytic solution creeps upwards along the electrode surfaces and leaks out of the cell container. This is a problem. Thus, the electrode materials or sealing valves have been so far coated with pitch tar, epoxy resin, etc. as a means of suppressing creeping-up or leakage of the electrolytic solution.

### DISCLOSURE OF THE INVENTION

### Problem to be Solved by the Invention

An object of the present invention is to provide a perfluoropolyether oil composition having an action to protect metal surfaces from corrosive gases such as sulfide gases, etc. without impairing the abrasion resistance. Another object of the present invention is to provide a perfluoropolyether oil composition with a distinguished high temperature durability even in the presence of graphite or molybdenum disulfide. Other object of the present invention is to provide a perfluoropolyether oil composition capable of suppressing creeping-up along the electrodes or leakage of the electrolytic solution only by coating of the composition to the electrode surfaces of a cell.

### Means for Solving the Problem

These objects of the present invention can be attained by a perfluoropolyether oil composition, which comprises a perfluoropolyether base oil, preferably a thickener-containing perfluoropolyether base oil, and a fluorine-containing di- or mono-amide-based compound. Fluorine-containing di- or mono-amide-based compound for use in the present invention includes those usually with a perfluoropolyether group. When the perfluoropolyether oil composition is used as a lubricant composition, particularly as grease, the amide-based compound is used in a proportion of 0.01 to 50% by weight, based on total weight of the base oil and the amide-based compound, and when used as an electrode-coating agent in the cell, the amide-based compound is used in a proportion of 0.01 to 90% by weight on the same basis.

### EFFECT OF THE INVENTION

A perfluoropolyether oil composition, which comprises a perfluoropolyether base oil, preferably a thickener-containing perfluoropolyether base oil, and 0.01 to 50% by weight of at least one of a fluorine-containing diamide-based compound having a perfluoropolyether group and a fluorine-containing monoamide-based compound having a perfluoropolyether group, when used as a lubricant composition, particularly as grease, has an abrasion resistance and a strong action to protect metal surfaces from corrosive gases such as sulfide gases, etc. The fluorine-containing amide-based compound additives have an action to suppress deterioration of perfluoropolyether oil by graphite or molybdenum disulfide upon adsorption onto graphite, molybdenum disulfide, etc. coming from bearing materials or external surroundings.

High temperature characteristics (high temperature durability) of perfluoropolyether oil are abruptly lowered due not only to the structure as to whether or not there are (CT₂O)ₙ groups as repeat unite in the polymer, but also to contact with graphite or molybdenum disulfide used as one component of the sintered oilless bearings. However, the present invention provides a perfluoropolyether oil composition without any substantial influence of repeat units in the polymer and furthermore without any considerable deterioration of high temperature characteristics, even if used in situations allowing contact with graphite or molybdenum disulfide from sintered oilless bearings containing graphite or molybdenum disulfide or in situations allowing contact with metallic parts of ball bearings, etc. containing graphite or molybdenum disulfide. The situations allowing contact with metallic parts include atomosphere where graphite or molybdenum disulfide may be scattered or contaminated, for example, graphite or molybdenum disulfide originating from motor parts such as brushes, shafts, etc. may be brought into contact. The situations with scattered or contaminated graphite or molybdenum disulfide are not limited to those mentioned above.

The perfluoropolyether oil composition comprising 0.01 to 90% by weight of at least one of fluorine-containing diamide-based compound and fluorine-containing monoamide-based compound, when used upon application of a voltage to electrodes of a cell, can effectively suppress occurrences of such phenomena as creeping-up of the electrolytic solution along the electrode surfaces and the resulting leakage from the cell container, because it seems that the perfluoropolyether oil composition, when used for coating, has a distinguished adsorbability onto the surfaces of electrode metallic materials, thereby eliminating clearances therebetween to suppress the creeping-up of the electrolytic solution.

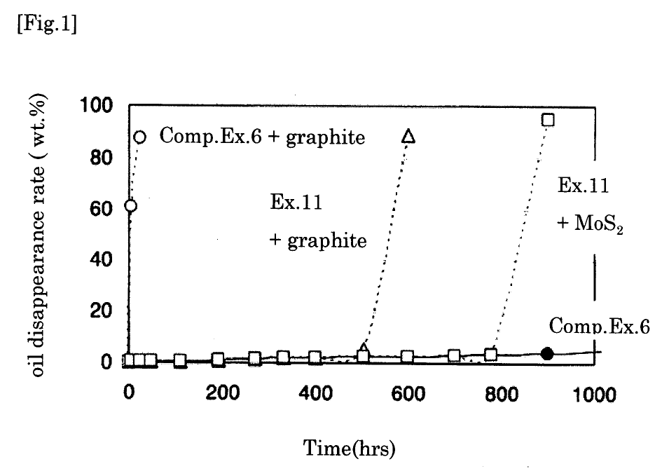

### BRIEF DESCRIPTION OF THE DRAWING

[FIG. 1] is a graph showing changes in oil disappearance rate with time at 200° C. when graphite or molybdenum disulfide is added to perfluoropolyether oil.

### BEST MODES FOR CARRYING OUT THE INVENTION

Perfluoropolyether oil represented by the following general formulae can be used as a base oil,
RfO(CF₂O)ₓ(C₂F₄O)_{y}(C₃F₆O)_{z}Rf
and above all those with (CF₂O)ₙ groups as repeat units in the polymer can be effectively used. Specifically, those represented, for example, by the following general formulae (1) to (3) can be used. In addition, those represented by the following general formula (4) can be also used. In the formulae (1) to (3), Rf is a perfluoro lower alkyl group having 1 to 5 carbon atoms, preferably 1 to 3 carbon atoms, such as perfluoromethyl group, perfluoroethyl group, perfluoropropyl group, etc.
RfO(CF₂CF₂O)ₘ(CF₂O)ₙRf (1)
, where m+n=3˜200, m:n=10˜90:90˜10, and CF₂CF₂O groups and CF₂O groups are bonded at random in the main chain, and which can be prepared by complete fluorination of precursors formed by photooxidation polymerization of tetrafluoroethylene.
RfO[CF(CF₃)CF₂O]ₚ(CF₂CF₂O)_{q}(CF₂O)ᵣRf (2)
, where p+q+r=3˜200, q and r can be 0, (q+r)/p=0˜2:1, and CF(CF₃)CF₂O groups, CF₂CF₂O groups, and CF₂O group are bonded at random in the main chain, and which can be prepared by complete fluorination of precursors formed by photooxidation polymerization of hexafluoropropene and tetrafluoroethylene.
RfO[CF(CF₃)CF₂O]ₛ(CF₂CF₂O)ₜRf (3)
, where s+t=2˜200, t can be 0, t/s=0˜2:1, and CF(CF₃)CF₂O groups and CF₂CF₂O groups are bonded at random in the main chain, and which can be prepared by complete fluorination of precursors formed by photo-oxidation of hexafluoropropene and tetrafluoroethylene, or prepared by anionic polymerization of hexafluoropropylene oxide or tetrafluoroethylene oxide in the presence of a cesium fluoride catalyst, followed by fluorine gas treatment of the resulting CF(CF₃)COF group-terminated acid fluoride compound.
F(CF₂CF₂CF₂O)_{2˜100}C₂F₅ (4)
, which can be prepared by anionic polymerization of 2,2,3,3-tetrafluoro-oxetane in the presence of a cesium fluoride catalyst, followed by fluorine gas treatment of the resulting fluorine-containing polyether (CH₂CF₂CF₂O)ₙ at about 160° to about 300° C. under ultraviolet irradiation.

When the perfluoropolyether oil composition is used as a lubricant composition, particularly as grease, a fluorine-containing amide-based compound is added as an additive to at least one of the aforementioned perfluoropolyether oils (1), (2), (3) and (4). The fluorine-containing amide-based compound is added in a proportion of 0.01 to 50% by weight, based on total weight of these respective components. That is, 0.01 to 50% by weight, preferably 0.1 to 40% by weight, of at least one of the fluorine-containing amide-based compound is added as an additive to 50 to 99.99% by weight, preferably 60 to 99.9% by weight, of at least one of preferably thickener-containing perfluoropolyether oils (1) to (4).

The fluorine-containing amide-based compound for use as an additive to the perfluoropolyether oil is generally at least one of fluorine-containing diamide-based compounds having a perfluoropolyether group and fluorine-containing monoamide-based compounds having a perfluoropolyether group, which include, for example, aliphatic amide-based compounds represented by the following general formulae [I], [II], and [III]. The aliphatic amide-based compounds have an improved adsorbability onto metals due to the absence of steric hindrance, and their shielding effect against corrosive gases has been recognized.
RCONHR₁NHCOR [I]
R₂NHCOR [II]
R₂NHCOR′ CONHR₂ [III]
, where
   R₁: an alkylene group having 1 to 30 carbon atoms, where a part or all of the hydrogen atoms of the alkylene group may be substituted with halogen atoms,
   R₂: an alkyl group having 1 to 31 carbon atoms, where a part or all of the hydrogen atoms of the alkyl group may be substituted with halogen atoms,
R: RfO[CF(CF₃)CF₂O]ₐCF(CF₃)—, RfO(CF₂CF₂CF₂O)ₐCF₂CF₂—, RfO [(CF₂CF₂O)ₐ(CF₂O)_{b}]CF₂—, or RfO[(CF₂CF₂O)ₐ(CF₂O)_{b}]CF(CF₃)—, where Rf is a perfluoro lower alkyl group having 1 to 5 carbon atoms, preferably 1 to 3 carbon atoms, and a and b are integers of 1 to 30, respectively,
   R′: —[CF(CF₃)CF₂O]ₐCF(CF₃)—, —(CF₂CF₂CF₂O)ₐCF₂CF₂—, —[(CF₂CF₂O)ₐ(CF₂O)_{b}]CF₂—, or —[(CF₂CF₂O)ₐ(CF₂O)_{b}]CF(CF₃)—, where a and b are integers of 1 to 30, respectively.

The fluorine-containing amide-based compounds having a perfluoropolyether group can suppress permeation of corrosive gases (sulfide gases, hydrogen chloride gas, sulfur dioxide gas, ammonia, etc.) or lowering of the high temperature durability even in the presence of graphite or molybdenum disulfide, as compared with cases only of the aforementioned preferably thickener-containing perfluoropolyether oils (1) to (4). That is, perfluoropolyether oil (1) has the highest viscosity index, lowest volatility and lowest friction coefficient among the aforementioned perfluoropolyether oils, but the presence of (CF₂O)ₙ group in the molecule weakens the permeation effect of C—F bonds against the corrosive gases, resulting in corrosion of metallic pieces, or lowering of the high temperature durability in the presence of graphite or molybdenum disulfide, and the perfluoropolyether oil (2) having a (CF₂O)ₙ group likewise allows permeation of corrosive gases in spite of its distinguished abrasion resistance, resulting in corrosion of metals, and lowering of the high temperature durability in the presence of graphite or molybdenum disulfide, but addition of fluorine-containing organic amide-based compound can suppress permeation of corrosive gases and lowering of the high temperature durability even in the presence of graphite or molybdenum disulfide. The perfluoropolyether oils (3) and (4) per se have the suppression effect of C—F bonds against corrosive gases, but addition of fluorine-containing organic amide-based compound can further show a suppression effect on corrosive gas permeation.

Perfluoropolyether oil having a kinetic viscosity at 40° C. in a range of 2 to 2,000 mm²/sec, preferably 5 to 1,500 mm²/sec, can be used as a base oil, to which the fluorine-containing amide-based compounds are to be added. When the kinetic viscosity is less than 2 mm²/sec, an increase in evaporation loss, a decrease in oil film strength, etc. leading to shortening of lifespan, abrasion or seizure may occur, whereas when the kinetic viscosity in above 2,000 mm²/sec, such inconveniences as an increase in power consumption or torque due to an increase in viscous resistance, etc. may be encountered.

A thickener can be added to the base oil together with the fluorine-containing amide-based compound. Polytetrafluoroethylene, tetrafluoroethylene-hexafluoropropene copolymer, perfluoroalkylene resin, etc. so far used as a lubricant can be employed as a thickener. Polytetrafluoroethylene can be prepared by emulsion polymerization, suspension polymerization, solution polymerization, etc. of tetrafluoroethylene, and polytetrafluoroethylene having a number average molecular weight Mn of about 1,000 to about 1,000,000, obtained by further treatment thereof, such as thermal decomposition, electron beam irradiation decomposition, physical disintegration, etc., can be used herein. Tetrafluoroethylene-hexafluoropropene copolymer having a number average molecular weight Mn of about 1,000 to about 600,000, obtained by copolymerization reaction of tetrafluoroethylene and hexaflu-oropropene and by molecular weight-reducing treatment as in the case of polytetrafluoroethylene, can be used herein. Molecular weight control can be also carried out by using a chain transfer agent during the copolymerization reaction. The powdery fluororesins thus obtained have an average primary particle size of generally about 500 μm or less, preferably about 0.1 to about 30 μm.

Other thickeners than the fluororesin for use in the present invention include, for example, metal soap such as Li soap, etc., urea resin, minerals such as bentonite, etc., organic pigments, polyethylene, polypropylene, and polyamide. From the viewpoint of heat resistance and lubricability, it is preferable to use aliphatic dicarboxylic acid metal salts, monoamide monocarboxylic acid metal salts, monoester carboxylic acid metal salts, diurea, triurea, tetraurea, etc.

The fluororesin powder, metal soap, urea and other thickeners can be used in a proportion of 50% by weight or less, generally 0.1 to 50% by weight, preferably 1 to 40% by weight, based on total weight with the base oil and the additive. When the thickener is used in a proportion of more than 50% by weight, the composition will become too hard, whereas in a proportion of less than 0.1% by weight the thickening ability of the fluororesin, etc. will not be demonstrated, resulting in deterioration such as oil separation, and a satisfactory increase in scattering-leakage resistances would not be expectable.

Other additives so far used in the lubricant such as an antioxidant, a rust preventive, an anti-corrosion agent, an extreme pressure additive, an oiliness agent, other solid lubricants than the fluororesin, etc. can be added, if necessary, to the composition. The antioxidant includes, for example, phenol-based antioxidants such as 2,6-di-t-butyl-4-methylphenol, 4,4′-methylenebis(2,6-di-t-butylphenol), etc., and amine-based antioxidants such as alkyldiphenylamine, triphenylamine, phenyl-α-naphthylamine, phenothiazine, alkylated phenyl-α-naphthyl-amine, phenylhiazine, alkylated phenylhiazine, etc.

The rust preventive includes, for example, fatty acids, fatty acid amines, alkylsulfonic acid metal salts, alkylsulfonic acid amine salts, oxidized paraffin, polyoxyethylene alkyl ether, etc. The anti-corrosion agent includes, for example, benzotriazole, benzoimidazole, thiadiazole, etc.

The extreme pressure additive includes, for example, phosphorus-based compounds such as phosphoric acid ester, phosphorous acid ester, phosphoric acid ester amine salts, etc., and sulfur-based compounds such as dialkyldithiophosphoric acid metal salts, dialkyldithiocarbamic acid metal salts, etc.

The oiliness agent includes, for example, fatty acids, or their esters, higher alcohols, polyhydric alcohols, or their esters, aliphatic amines, fatty acid monoglycerides, etc. Other solid lubricants than the fluororesin includes, for example, molybdenum disulfide, graphite, boron nitride, silane nitride, etc.

The perfluoropolyether oil composition when used as an electode-coating agent for a cell, comprises at least one of the perfluoropolyether oils (1), (2), (3) and (4), and 0.01 to 90% by weight, preferably 0.1 to 60% by weight, of a fluorine-containing amide-based compound having a perfluoropolyether group as an additive, based on total weight of these respective components.

In the case of using the composition as an electrode-coating agent, it is preferable to use urea resin, polytetrafluoroethylene, tetrafluoroethylene-hexafluoropropene copolymer, perfluoroalkylene resin, organic pigments, polyethylene, polypropylene, polyamide, etc. as a thickener in addition to the aforementioned respective components, where the thickener can be used in a proportion of 50% by weight or less, generally 0.1 to 50% by weight, preferably 10 to 40% by weight, based on total weight with perfluoropolyether oil and additives.

Furthermore, other solid lubricants than the fluorocresin, such as molybdenum disulfide, graphite, boron nitride, silane nitride, etc. can be used herein.

The composition can be prepared by a method (a) comprising adding predetermined amounts of a fluorine-containing organic amide-based compound, synthesized in advance, a thickener, and other necessary additives to perfluoropolyether base oil, followed by thorough kneading by the ordinary dispersion method, such as three rolls, or a high pressure homogenizer, or by a method (b) comprising adding perfluoropolyether oil and an isocyanate to a heatable and agitatable reactor vessel, then heating the mixture, adding a predetermined amount of an amine thereto to start reaction, and then cooling the reaction product, followed by thorough kneading by three rolls or a high pressure homogenizer.

### EXAMPLES

The present invention will be described in detail below, referring to Examples.

### Examples 1-11 and Comparative Examples 1-6

[Base oil]

| A-1: perfluoropolyether | | | |
|---|---|---|---|
| base oil (1) | | | |
| RfO(CF₂CF₂O)ₘ(CF₂O)ₙRf | Viscosity(40° C.) | 85 | mm²/sec. |
| A-2: perfluoropolyether | | | |
| base oil (2) | | | |
| RfO[CF(CF₃)CF₂O]ₚ(CF₂O)ᵣRf | ″ | 400 | mm²/sec. |
| A-3: perfluoropolyether | | | |
| base oil (3) | | | |
| RfO[CF(CF₃)CF₂O]ₛRf | ″ | 100 | mm²/sec. |
| A-4: perfluoropolyether | | | |
| base oil (4) | | | |
| F(CF₂CF₂CF₂O)_{2˜100}C₂F₅ | ″ | 65 | mm²/sec. |
| A-5: perfluoropolyether | | | |
| base oil (5) | | | |
| RfO(CF₂CF₂O)ₘ(CF₂O)ₙRf | ″ | 160 | mm²/sec. |
| A-6: poly-α-olefin | ″ | 30 | mm²/sec. |
| A-7: fluorosilicone | ″ | 300 | mm²/sec. |

[Additive]
B-1: RfO[CF(CF₃)CF₂O]ₙCF(CF₃)—CONH—CH₂CH₃
B-2: RfO[CF(CF₃)CF₂O]ₙCF(CF₃)—CONH—C₄H₈—NHCO—CF(CF₃)[OCF₂CF(CF₃)]ₙORf
B-3: CH₃CH₂—NHCO—[(CF₂CF₂O)ₘ(CF₂O)ₙ]CF₂—CONH—CH₂CH₃
   [Thickener]
C-1: Emulsion polymerization process polytetrafluoroethylene (number average molecular weight Mn: about 100,000˜about 200,000; average primary particle size: 0.2 μm)
C-2: Suspension polymerization process polytetrafluoroethylene (number average molecular weight Mn: about 10,000˜about 100,000; average primary particle size: 5 μm)
C-3: Solution polymerization process tetrafluoroethylene-hexafluoro-propene copolymer
   (number average molecular weight Mn: about 50,000˜about 150,000; average primary particle size: 0.2 μm)
C-4: Lithium azelate
C-5: Reaction product of hexamethylene diisocyanate and octyl amine

The aforementioned base oils, additives and thickeners were combined together to prepare perfluoropolyether oil compositions according to the aforementioned method (a), and performances of the compositions were evaluated according to the following test procedures:

[Sulfide Gas Test]

Copper plates or silver plates (40 mm×40 mm×5 mm) were used as test pieces and subjected to corrosion tests in a constant flow rate, flow type gas corrosion tester under conditions of H₂S concentration: 3%, temperature: 40° C., humidity: 90%, and duration: 96 hours, and after the corrosion test the test pieces removing greases by wiping were subjected to EDS (energy-dispersive X-ray spectrometry) analysis for evaluation, where i.e. detection of sulfur was identified by “yes” and non-detection by “none”.

[Abrasion Resistance Evaluation Test with Respect to Mating Material]

SUJ 2 (½ inch), grade 20 was used as test pieces, and subjected to an abrasion test by a Shell four-ball test under conditions of number of revolutions: 20 rounds per sec., load: 392.3N (40 Kgf); temperature: room temperature; duration: 60 minutes to determine sizes of abrasion marks on the test pieces resulting from the test.

The test results are shown in the following Table 1 together with combinations of base oils, additives and thickeners used.

TABLE 1

| | | | | Sulfide gas test | | |
|---|---|---|---|---|---|---|
| | Base oil | Additive | Thickener | Copper | Silver | Abrasion test |
| Example | (wt. %) | (wt. %) | (wt. %) | plate | plate | Abrasion mark |
| Ex. 1 | A-1 (50) | B-1 (20) | C-1 (30) | none | none | 0.7 mm |
| Ex. 2 | A-1 (50) | B-1 (10) | C-1 (30) | none | none | 0.8 mm |
| | | B-2 (10) | | | | |
| Ex. 3 | A-2 (50) | B-2 (20) | C-1 (30) | none | none | 0.6 mm |
| Ex. 4 | A-2 (40) | B-2 (20) | C-2 (40) | none | none | 0.7 mm |
| Ex. 5 | A-1 (50) | B-1 (10) | C-1 (30) | none | none | 0.8 mm |
| | | B-2 (10) | | | | |
| Ex. 6 | A-2 (40) | B-2 (30) | C-3 (30) | none | none | 0.6 mm |
| Ex. 7 | A-2 (60) | B-1 (20) | C-1 (10) | none | none | 0.9 mm |
| | | | C-4 (10) | | | |
| Ex. 8 | A-1 (30) | B-1 (20) | C-2 (30) | none | none | 0.9 mm |
| | A-3 (20) | | | | | |
| Ex. 9 | A-1 (30) | B-1 (20) | C-2 (30) | none | none | 0.8 mm |
| | A-4 (20) | | | | | |
| Ex. 10 | A-1 (60) | B-3 (20) | C-1 (20) | none | none | 0.9 mm |
| Ex. 11 | A-5 (97) | B-2 (3) | — | none | none | 0.9 mm |
| Comp. Ex. 1 | A-1 (70) | — | C-1 (30) | yes | yes | 1.1 mm |
| Comp. Ex. 2 | A-2 (70) | — | C-1 (30) | yes | yes | 1.0 mm |
| Comp. Ex. 3 | A-6 (70) | — | C-4 (30) | yes | yes | 0.5 mm |
| Comp. Ex. 4 | A-6 (91) | — | C-5 (9) | yes | yes | 0.7 mm |
| Comp. Ex. 5 | A-7 (70) | — | C-1 (30) | none | none | 2.4 mm |
| Comp. Ex. 6 | A-5 (100) | — | — | yes | yes | 1.4 mm |

0.6 g of test samples made up of perfluoropolyether oil composition of Example 11 or perfluoropolyether oil of Comparative Example 6 and 10% by weight of graphite powder (flaky graphite power CB-150, a product of Japan Graphite Co; fixed carbon content: 98.0% or more; average particle size: 40 μm) or molybdenum disulfide (LM13-SM powder, a product of Daito Lubricant Co.; average particle size: 0.4 μm), as based on the total weight of sample, was sampled out into a glass Petri dish having a diameter of 37 mm and after uniform smearing on the dish, gently placed in a thermostat tank at 200° C. to determine changes in oil weight loss rate (oil disappearance rate) with time.

The results are graphically shown in FIG. 1, from which it is evident that the perfluoropolyether oil having (CF₂O)ₙ groups as repeat units in the polymer has no high temperature durability in the presence of graphite or molybdenum disulfide, and the oil is rapidly evaporated off and volatilized off, and disappears, but the presence of a fluorine-containing amide-based compound can considerably enhance the high temperature durability.

### Examples 12-14 and Comparative Examples 7-8

The aforementioned base oils, additives, and thickeners were combined together, and prepared into perfluoropolyether oil compositions according to the aforementioned method (a). The oil composition was uniformly applied by coating onto peripheral surfaces each of two 5 mm-radius columnar electrodes, to a width of 10 mm in the longitudinal direction and a thickness of 0.5 mm. The two electrodes were dipped into an electrolytic solution, so that coating-applied surfaces may not be dipped into the electrolytic solution and the lower ends each of the coating-applied surfaces may be located by 1 mm higher than the liquid level of the electrolytic solution, while applying a voltage of 1.5V between the two electrodes, time until the electrolytic solution creeped upwards over the coating-applied surfaces to reach the upper ends thereof or higher was determined.

The results are shown in the following Table 2 together with the combinations of the base oils, additives, and thickeners used.

TABLE 2

| | Base oil | Additive | Thickener | Creeping-up |
|---|---|---|---|---|
| Example | (wt. %) | (wt. %) | (wt. %) | time (hrs) |
| Ex. 12 | A-2(60) | B-2(10) | C-1(30) | >600 |
| Ex. 13 | A-2(45) | B-2(25) | C-1(30) | >600 |
| Ex. 14 | A-2(20) | B-2(50) | C-1(30) | >600 |
| Comp. Ex. 7 | A-1(70) | — | C-1(30) | 24 |
| Comp. Ex. 8 | A-2(70) | — | C-1(30) | 24 |

### INDUSTRIAL UTILITY

The present perfluoropolyether oil composition can be effectively used as a metal surface-protective material for metallic materials exposed to the atmosphere of corrosive gases such as a hydrogen sulfide gas, a hydrogen chloride gas, a sulfur dioxide gas, etc. in the application fields using perfluoropolyether oil heretofore as a lubricant composition, particularly grease, for example, at contact position between sliding members such as ball-and-roller bearings, plain bearings, sintered bearings, gears, valves, cocks, oil seals, electric contacts, etc.

More particularly, the present perfluoropolyether oil composition can be effectively used for corrosion protection of metal surfaces used in bearings requiring a heat resistance, a low temperature resistance, and a load carrying capacity, typically hub units, traction motors, fuel injectors, alternators, etc. of automobiles; gears requiring an abrasion resistance, low friction characteristics, and high torque efficiency, typically power transmission systems, power wind motors, wiper, etc. of automobiles; bearings requiring a low torque and a low outgas characteristics, typically hard discs, flexible disc memory devices, compact disc drives, and optomagnetic disc drives used in information technology devices; sliding parts of bearings, gears, etc. used in vacuum pumps, resin production machinery, conveyors, wood industry machinery, chromium coating apparatuses, etc. and electric contacts of electronic appliances used in breakers•isolators•relay-switch, etc.

The present perfluoropolyether oil composition can be effectively used as a lubricant for coating electrodes of a cell to prevent creeping-up of the electrode surface of an electrolytic solution or leakage of an electrolytic solution from the cell container even upon application of a voltage between the electrodes when used by coating on the electrodes of a cell such as a primary cell, a secondary cell, etc.

1: A perfluoropolyether oil composition, which comprises a perfluoropolyether base oil, and 0.01-90% by weight of a fluorine-containing di- or mono-amide-based compound, based on total weight of the respective components.

2: A perfluoropolyether oil composition according to claim 1, wherein the perfluoropolyether base oil has a viscosity (40° C.) of 2 to 2,000 mm²/sec.

3: A perfluoropolyether oil composition according to claim 1, wherein the fluorine-containing di- or mono-amide-based compound is an amide-based compound having a perfluoropolyether group.

4: A perfluoropolyether oil composition according to claim 3, wherein the amide-based compound having a perfluoropolyether group is an aliphatic amide-based compound.

5: A perfluoropolyether oil composition according to claim 3, wherein the amide-based compound having a perfluoropolyether group is a compound represented by the following general formula:
RCONHR₁NHCOR [I]
, where R is RfO[CF(CF₃)CF₂O]ₐCF(CF₃)—, RfO(CF₂CF₂CF₂O)ₐCF₂CF₂—, RfO[(CF₂CF₂O)ₐ(CF₂O)_{b}]CF₂—, or RfO[(CF₂CF₂O)ₐ(CF₂O)_{b}]CF(CF₃)—, Rf is a perfluoro lower alkyl group having 1 to 5 carbon atoms, and a and b are integers of 1 to 30, respectively, and R₁ is an alkylene group having 1 to 30 carbon atoms, a part or all of the hydrogen atoms of the alkylene group may be substituted by halogen atoms.

6: A perfluoropolyether oil composition according to claim 3, wherein the amide-based compound having a perfluoropolyether group is a compound represented by the following general formula:
R₂NHCOR [II]
, where R is RfO[CF(CF₃)CF₂O]ₐCF(CF₃)—, RfO(CF₂CF₂CF₂O)ₐCF₂CF₂—, RfO[(CF₂CF₂O)ₐ(CF₂O)_{b}]CF₂—, or RfO[(CF₂CF₂O)ₐ(CF₂O)_{b}]CF(CF₃)—, Rf is a perfluoro lower alkyl group having 1 to 5 carbon atoms, and a and b are integers of 1 to 30, respectively, and R₂ is an alkyl group having 1 to 31 carbon atoms, a part or all of the hydrogen atoms of the alkyl group may be substituted with halogen atoms.

7: A perfluoropolyether oil composition according to claim 3, wherein the amide-based compound having a perfluoropolyether group is a compound represented by the following general formula:
R₂NHCOR′CONHR₂ [III]
, wherein R′ is —[CF(CF₃)CF₂O]ₐCF(CF₃)—, —(CF₂CF₂CF₂O)ₐCF₂CF₂—, —[(CF₂CF₂O)ₐ(CF₂O)_{b}]CF₂—, or —[(CF₂CF₂O)ₐ(CF₂O)_{b}]CF(CF₃)—, and a and b are integers of 1 to 30 respectively, R₂ is an alkyl group having 1 to 31 carbon atoms, a part or all of the hydrogen atoms of the alkyl group may be substituted with halogen atoms.

8: A perfluoropolyether oil composition according to claim 1, wherein the fluorine-containing di- or mono-amide-based compound is used in a proportion of 0.01 to 50% by weight, based on total weight of the base oil and the amide-based compound, and used as a lubricant composition.

9: A perfluoropolyether oil composition according to claim 8, wherein the lubricant composition is a grease.

10: A perfluoropolyether oil composition according to claim 8, wherein a thickener is further contained in the composition.

11: A perfluoropolyether oil composition according to claim 8, wherein at least one of an antioxidant, a rust preventive, a anti-corrosion agent, an extreme pressure additive, an oiliness agent, and other solid lubricant than fluororesin is further contained in the composition.

12: A perfluoropolyether oil composition according to claim 10, wherein at least one of an antioxidant, a rust preventive, an anti-corrosion agent, an extreme pressure additive, an oiliness agent and other solid lubricants than fluororesin is further contained in the composition.

13: A perfluoropolyether oil composition according to claim 8, for use as a metal surface protective agent against corrosive gases.

14: A perfluoropolyether oil composition according to claim 10, for use as a metal surface protective agent against corrosive gases.

15: A perfluoropolyether oil composition according to claim 13, wherein the corrosive gases are a sulfide gas.

16: A perfluoropolyether oil composition according to claim 14, wherein the corrosive gases are a sulfide gas.

17: A perfluoropolyether oil composition according to claim 1, for use as impregnated into a sintered oilless bearing comprising graphite or molybdenum disulfide as a sintering component.

18: A lubricating oil composition according to claim 1, for use in contact with metallic parts containing graphite or molybdenum disulfide.

19: A lubricating oil composition according to claim 1, for use in application fields in an atmosphere with scattered or contaminated graphite or molybdenum disulfide.

20: A perfluoropolyether oil composition according to claim 1, wherein the fluorine-containing di- or mono-amide-based compound is used in a proportion of 0.01 to 90% by weight, based on total weight of the base oil and the amide-based compound, and is used as a electrode-coating agent for a cell.

21: A perfluoropolyether oil composition according to claim 20, wherein a thickener is further contained in the composition.

22: A perfluoropolyether oil composition according to claim 20, wherein another solid lubricant than fluororesin is further contained in the composition.

23: A perfluoropolyether oil composition according to claim 21, wherein another solid lubricant than fluororesin is further contained in the composition.
